(19) United States
(12) Patent Application Publication
(10) Pub. No.: US 2025/0332920 A1
(43) Pub. Date: Oct. 30, 2025

(54) IN-VEHICLE DISPLAY DEVICE

(71) Applicants: TOYOTA JIDOSHA KABUSHIKI KAISHA, Toyota-shi (JP); DENSO CORPORATION, Kariya-shi (JP)

(72) Inventor: Hironori ITO, Tokyo (JP)

(73) Assignees: TOYOTA JIDOSHA KABUSHIKI KAISHA, Toyota-shi (JP); DENSO CORPORATION, Kariya-shi (JP)

(21) Appl. No.: 19/064,946

(22) Filed: Feb. 27, 2025

(30) Foreign Application Priority Data
Apr. 24, 2024 (JP) 2024-070407

(51) Int. Cl. B60K 35/81; B60K 35/22; B60R 1/22

(52) U.S. Cl. CPC B60K 35/81; B60K 35/22; B60R 1/22; B60K 2360/176; B60K 2360/21; B60R 2300/804

(57) ABSTRACT

The in-vehicle display includes: a recognition unit configured to recognize a lane marking of a traveling lane based on a captured image of a camera; a determination unit configured to determine whether or not an operation condition of lane-keeping control is satisfied; and a display controller configured to display the recognized lane marking on a display. The display controller is configured to display the lane marking after a display standby time elapses when the determination unit determines that the operation condition is satisfied when the recognition unit starts the recognition of the lane marking.

### CROSS-REFERENCE TO RELATED APPLICATIONS

This application is based upon and claims the benefit of priority from Japanese Patent Application No. 2024-070407, filed on Apr. 24, 2024, the entire contents of which are incorporated herein by reference.

### BACKGROUND

### Field

The present disclosure relates to an in-vehicle display device that displays a lane marking of a traveling lane on a display of a vehicle.

### Description of the Related Art

For example, Japanese Unexamined Patent Publication No. 2018-103863 discloses a device that recognizes a lane marking of a traveling lane and executes lane-keeping control of causing a vehicle to travel along the recognized lane marking. In the device, a lane marking recognized based on a captured image of a camera is displayed on a display, and an occupant is notified that a vehicle is traveling along the displayed lane marking.

### SUMMARY

In the above-described device, after the recognition of the lane marking required for the lane-keeping control is started, the execution of the lane-keeping control is started. Therefore, the recognized lane marking is displayed on the display, but the lane-keeping control is not operated until the preparation for executing the lane-keeping control is completed. As a result, the occupant may feel incompatibility for the lane-keeping control not being in operation even though the lane marking required for the lane-keeping control is displayed.

Therefore, the present disclosure describes an in-vehicle display device capable of displaying a lane marking used for lane-keeping control while reducing a feeling of incompatibility of an occupant.

An aspect of the present disclosure is [1] “an in-vehicle display device that displays a lane marking of a traveling lane on which a vehicle travels on a display mounted on the vehicle, the in-vehicle display device including: a recognition unit configured to recognize the lane marking of the traveling lane based on a captured image of a camera; a determination unit configured to determine whether or not an operation condition of lane-keeping control of causing the vehicle to travel along the recognized lane marking is satisfied, the operation condition being set based on at least one of a state of the vehicle, a shape of the traveling lane, and a state of a driver of the vehicle; and a display controller configured to display the recognized lane marking on the display, in which the display controller is configured to display the lane marking after a display standby time set in advance elapses when the determination unit determines that the operation condition is satisfied when the recognition unit starts the recognition of the lane marking”.

When it is determined that the operation condition of the lane-keeping control is satisfied when the recognition of the lane marking is started, the in-vehicle display device displays the lane marking after the display standby time elapses. Accordingly, in the in-vehicle display device, the lane marking is not displayed before the operation of the lane-keeping control, or a time during which the lane marking is displayed before the operation of the lane-keeping control can be shortened. Therefore, it is possible to reduce a feeling of incompatibility of the occupant about the lane-keeping control not being in operation even though the lane marking required for the lane-keeping control is displayed. As described above, the in-vehicle display device can display the lane marking used for the lane-keeping control while reducing a feeling of incompatibility of the occupant.

An aspect of the present disclosure may be [2] “the in-vehicle display device according to [1] described above, in which the display controller is configured to not display the recognized lane marking when the determination unit does not determine that the operation condition is satisfied when the recognition unit starts the recognition of the lane marking, and display, when it is determined that the operation condition is satisfied thereafter, the lane marking after the display standby time elapses after it is determined that the operation condition is satisfied”.

Accordingly, even when the operation condition of the lane-keeping control is not satisfied when the recognition of the lane marking is started, the in-vehicle display device can display the lane marking at a more appropriate timing while reducing a feeling of incompatibility of the occupant after the operation condition is satisfied.

An aspect of the present disclosure may be [3] “the in-vehicle display device according to [1] or [2] described above, in which the display controller increases the display standby time when the vehicle travels on a general road, as compared with a case where the vehicle travels on a highway”.

Here, when the vehicle is traveling on the general road, stability of the recognition of the lane marking based on the captured image of the camera tends to be lower as compared with a case where the vehicle is traveling on the highway. Therefore, by increasing the display standby time when the vehicle is traveling on the general road, it is possible to secure an increased time for the recognition processing from the start of the recognition of the lane marking to the display of the lane marking, and it is possible to increase the stability of the recognition of the lane marking. Accordingly, the in-vehicle display device can display the lane marking in a state where the stability of the recognition is high when the lane marking is displayed.

An aspect of the present disclosure may be [4] “the in-vehicle display device according to any one of [1] to [3] described above, in which the display controller increases the display standby time when a recognition length of the lane marking recognized by the recognition unit is short, as compared with a case where the recognition length of the lane marking is long”.

By increasing the display standby time when the recognition length of the lane marking is short, it is possible to secure increased time for the recognition processing of the lane marking from the start of the recognition of the lane marking to the display of the lane marking. Then, by securing the increased time for the recognition processing, the recognition length of the lane marking (the length of the recognized lane marking) can be increased. That is, for example, the lane marking at a position away from the vehicle can be recognized. Accordingly, the in-vehicle display device can display the lane marking having the long length when the lane marking is displayed.

An aspect of the present disclosure may be [5] “the in-vehicle display device according to any one of [1] to [4] described above, in which the display controller increases the display standby time when a speed of the vehicle is low, as compared with a case where the speed is high”.

By increasing the display standby time when the speed of the vehicle is low, it is possible to secure increased time for the recognition processing of the lane marking from the start of the recognition of the lane marking to the display of the lane marking. Then, by securing the increased time for the recognition processing, the recognition length of the lane marking (the length of the recognized lane marking) can be increased. That is, for example, the lane marking at a position away from the vehicle can be recognized. Accordingly, the in-vehicle display device can display the lane marking having the long length when the lane marking is displayed.

An aspect of the present disclosure may be [6] “an in-vehicle display device that displays a lane marking of a traveling lane on which a vehicle travels on a display mounted on the vehicle, the in-vehicle display device including: a recognition unit configured to recognize the lane marking of the traveling lane based on a captured image of a camera; a determination unit configured to determine whether or not an operation condition of lane-keeping control of causing the vehicle to travel along the recognized lane marking is satisfied, the operation condition being set based on at least one of a state of the vehicle, a shape of the traveling lane, and a state of a driver of the vehicle; and a display controller configured to display the recognized lane marking on the display, in which the display controller is configured to display the lane marking when the execution of the lane-keeping control is started when the determination unit determines that the operation condition is satisfied when the recognition unit starts the recognition of the lane marking”.

The in-vehicle display device displays the lane marking when the execution of the lane-keeping control is started. Accordingly, in the in-vehicle display device, it is possible to reduce a feeling of incompatibility of the occupant about the lane-keeping control not being in operation even though the lane marking required for the lane-keeping control is displayed. As described above, the in-vehicle display device can display the lane marking used for the lane-keeping control while reducing a feeling of incompatibility of the occupant.

An aspect of the present disclosure may be [7] “the in-vehicle display device according to [6] described above, in which the display controller is configured to not display the recognized lane marking when the determination unit does not determine that the operation condition is satisfied when the recognition unit starts the recognition of the lane marking, and display, when it is determined that the operation condition is satisfied thereafter, the lane marking when the execution of the lane-keeping control is started”.

Accordingly, even when the operation condition of the lane-keeping control is not satisfied when the recognition of the lane marking is started, the in-vehicle display device can display the lane marking at a more appropriate timing while reducing a feeling of incompatibility of the occupant after the operation condition is satisfied.

According to the various aspects of the present disclosure, it is possible to display a lane marking used for lane-keeping control while reducing a feeling of incompatibility of an occupant.

### BRIEF DESCRIPTION OF THE DRAWINGS

FIG. 1 is a block diagram showing an example of a lane-keeping control system according to a first embodiment.

FIG. 2 is a top view showing an example of a road on which a host vehicle travels.

FIG. 3 is a diagram showing an example of a display image of a lane marking on a display.

FIG. 4 is a flowchart showing a flow of display processing of the lane marking performed on an in-vehicle display device of the lane-keeping control system.

FIG. 5 is a block diagram showing an example of a lane-keeping control system according to a second embodiment.

FIG. 6 is a flowchart showing a flow of display processing of the lane marking performed on an in-vehicle display device of the lane-keeping control system.

### DETAILED DESCRIPTION

Hereinafter, exemplary embodiments will be described with reference to the drawings. In each figure, the same or corresponding elements are designated by the same reference numerals, and duplicate descriptions will not be repeated. In the following, a case where an in-vehicle display device according to the present disclosure is applied to a lane-keeping control system will be described as an example.

### First Embodiment

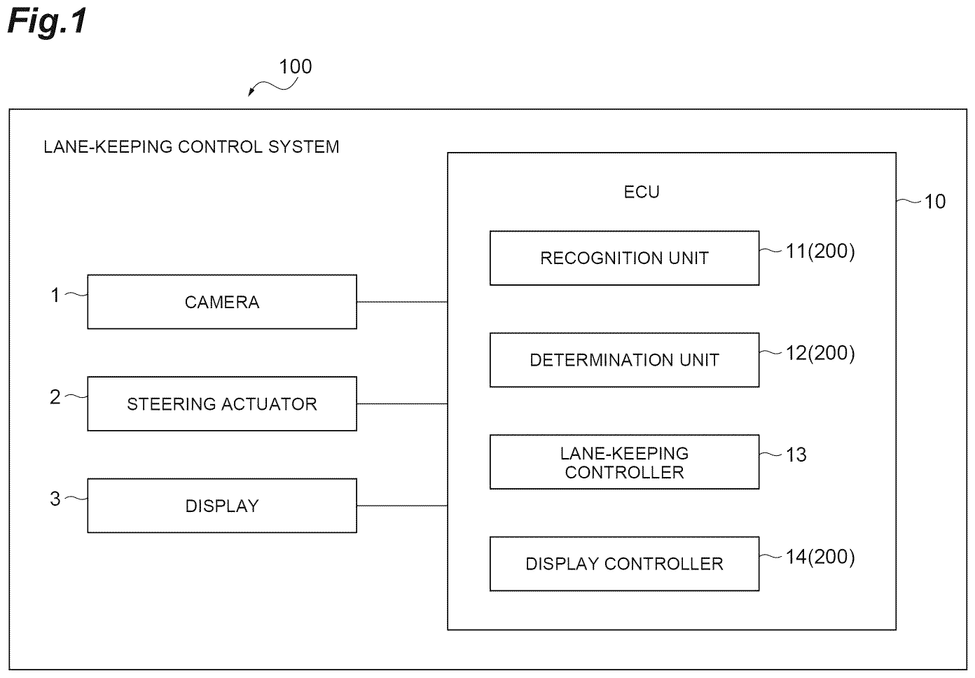

A first embodiment of the lane-keeping control system to which the in-vehicle display device according to the present disclosure is applied will be described. A lane-keeping control system 100 shown in FIG. 1 is mounted on a vehicle (hereinafter, referred to as a host vehicle) such as a passenger car and a freight car. The lane-keeping control system 100 executes lane-keeping control of traveling along an own lane that is a traveling lane on which the host vehicle travels, as driving support for the host vehicle. For example, the lane-keeping control is control of automatically performing steering of the host vehicle such that the host vehicle travels between a lane marking (a marking provided on a road to divide lanes) on a left side of the own lane and a lane marking on a right side of the own lane. In addition, the lane-keeping control system 100 displays a lane marking of the traveling lane on which the host vehicle travels on a display 3.

The lane-keeping control system 100 includes an electronic control unit (ECU) 10 that comprehensively manages the devices. The ECU 10 is an electronic control unit having a central processing unit (CPU) and a storage unit. The storage unit includes, for example, a read-only memory (ROM), a random-access memory (RAM), an electrically erasable programmable read-only memory (EEPROM), or the like. In the ECU 10, for example, various functions are implemented by the CPU executing a program stored in the storage unit. The ECU 10 may include a plurality of electronic units.

A camera 1, a steering actuator 2, and the display 3 are connected to the ECU 10. The camera 1 is imaging equipment that captures an image of an external situation of the host vehicle. The camera 1 is provided on a rear side of a windshield of the host vehicle, for example, and captures an image of a situation in front of the host vehicle. The camera 1 transmits a captured image related to the external situation of the host vehicle to the ECU 10. In the present embodiment, the camera 1 can image a road ahead of the host vehicle.

The steering actuator 2 controls steering of the host vehicle. For example, the steering actuator 2 controls driving of an assist motor that controls steering torque in an electric power steering system in accordance with a control signal from the ECU 10. Therefore, the steering actuator 2 controls the steering torque of the host vehicle.

The display 3 is a display device provided inside a vehicle cabin of the host vehicle. The display 3 may be a center display, a multi-information display (MID), or a head-up display (HUD). The display 3 displays various types of information in response to a control signal from the ECU 10.

Next, a functional configuration of the ECU 10 will be described. The ECU 10 functionally includes a recognition unit 11, a determination unit 12, a lane-keeping controller 13, and a display controller 14. The recognition unit 11, the determination unit 12, and the display controller 14 constitute an in-vehicle display device 200 that displays the lane marking of the traveling lane on which the host vehicle travels on the display 3.

The recognition unit 11 recognizes the lane marking of the own lane on which the host vehicle travels based on the captured image of the camera 1. Here, the recognition unit 11 recognizes a position of the lane marking in front of the host vehicle. For example, the recognition unit 11 extracts the lane marking using a known image processing technique based on the captured image, and recognizes the position of the lane marking with respect to the host vehicle. The recognition unit 11 may recognize each position of the lane marking on a line. The recognition unit 11 may recognize an absolute position of the lane marking represented by the latitude, the longitude, and the like as the position of the lane marking.

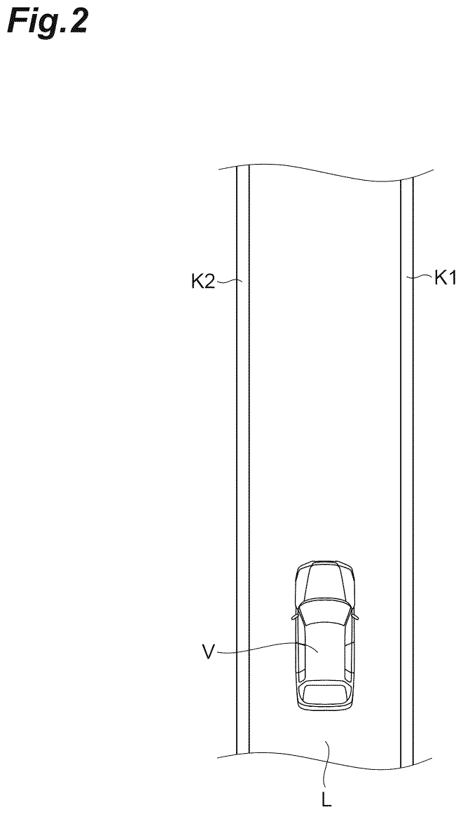

As shown in FIG. 2, for example, it is assumed that a host vehicle V is traveling on an own lane L. The own lane L is formed by a pair of lane markings which are a lane marking K1 and a lane marking K2. The lane marking K1 is a lane marking on a right side of the own lane L. The lane marking K2 is a lane marking on a left side of the own lane L. In this case, the recognition unit 11 recognizes positions of the lane markings K1 and K2 based on the captured image of the camera 1.

The determination unit 12 determines whether or not an operation condition of the lane-keeping control of causing the host vehicle to travel along the lane marking recognized by the recognition unit 11 is satisfied. The operation condition is defined in advance. In the present embodiment, the operation condition is set in advance based on at least one of a state of the host vehicle, a shape of the own lane (the traveling lane of the host vehicle), or a state of a driver of the host vehicle.

The operation condition defined based on the state of the host vehicle may be defined based on, for example, a speed of the host vehicle or a steering angle of the host vehicle. For example, when control is switched to the lane-keeping control when the speed of the host vehicle is high, it may be difficult to appropriately perform the lane-keeping control. Therefore, for example, as the operation condition defined based on the state of the host vehicle, a condition that the speed of the host vehicle is equal to or lower than a speed defined in advance may be defined. As the speed of the host vehicle, a detection result of a vehicle speed sensor installed in the host vehicle may be used. In addition, for example, when the control is switched to the lane-keeping control when the steering angle of the host vehicle is large, it may be difficult to appropriately perform the lane-keeping control. Therefore, for example, as the operation condition defined based on the state of the host vehicle, a condition that the steering angle of the host vehicle is equal to or less than a steering angle defined in advance may be defined. As the steering angle of the host vehicle, a detection result of a steering angle sensor installed in the host vehicle may be used.

The operation condition defined based on the state of the host vehicle may be defined based on presence or absence of a failure of a mechanism related to the steering of the host vehicle. For example, when the control is switched to the lane-keeping control when a failure occurs in the mechanism related to the steering of the host vehicle, such as the steering actuator 2, it may be difficult to appropriately perform the lane-keeping control. Therefore, for example, as the operation condition defined based on the state of the host vehicle, a condition that a failure does not occur in the mechanism related to the steering of the host vehicle may be defined. The presence or absence of the failure of the mechanism related to the steering of the host vehicle may be determined based on, for example, an operating state of the steering actuator 2, a diagnosis result of the steering actuator 2 in a well-known failure diagnosis system, and the like. In addition, for example, when a tire of the host vehicle is punctured, appropriate steering cannot be performed. Therefore, for example, as the operation condition defined based on the state of the host vehicle, a condition that a tire of the host vehicle is not punctured may be defined. Presence or absence of a puncture of a tire may be determined based on a detection result of a tire air pressure sensor attached to the tire or a wheel.

The operation condition defined based on the shape of the own lane may be defined based on, for example, a curvature of a curve of the road. For example, when the control is switched to the lane-keeping control when the curvature of the curve of the road is large (the curve is sharply bent), it may be difficult to appropriately perform the lane-keeping control. Therefore, for example, as the operation condition defined based on the shape of the own lane, a condition that a shape of the curve of the own lane (a shape of the curve in front of the host vehicle) has a curvature equal to or less than a curvature defined in advance may be defined. As the curvature of the curve, a curved state of the lane marking recognized by the recognition unit 11 may be used. In addition, the curvature of the curve may be acquired based on map information including a road shape. In this case, for example, the curvature of the curve of the own lane may be acquired based on the position of the host vehicle recognized based on a positioning result of a GPS reception unit and the map information including the road shape.

The operation condition defined based on the state of the driver of the host vehicle may be defined based on, for example, an orientation of a visual line of the driver, a posture of the driver, or a wakefulness state of the driver. The state of the driver can be determined, for example, based on a captured image of a driver monitor camera that images the driver. Estimation of the state of the driver based on the captured image of the driver monitor camera can be performed using various well-known image processing techniques.

For example, the control may be switched to the lane-keeping control when the driver looks at a place other than the front of the host vehicle (for example, a smartphone held in a hand, a side of the host vehicle, or the like). In such a state of the driver, when it is necessary to end the lane-keeping control because of, for example, occurrence of an unexpected sudden approach of an additional vehicle, it may be difficult for the driver to immediately take over a driving operation of the host vehicle. Therefore, for example, as the operation condition defined based on the state of the driver, a condition that the visual line of the driver is oriented within a range in front of the host vehicle, which is defined in advance, may be defined.

For example, the control may be switched to the lane-keeping control when the posture of the driver is in a state unsuitable for the driving operation, for example, when the driver is lying down with a seat tilted. In such a posture of the driver, when it is necessary to end the lane-keeping control because of, for example, occurrence of an unexpected sudden approach of an additional vehicle, it may be difficult for the driver to immediately take over a driving operation of the host vehicle. Therefore, for example, as the operation condition defined based on the state of the driver, a condition that the posture of the driver is a posture suitable for the driving operation, which is defined in advance, may be defined. Examples of the posture suitable for the driving operation include a posture in which the driver is not lying down and a posture in which the driver is seated on a driver's seat.

For example, the control may switch to the lane-keeping control when the wakefulness state of the driver is not suitable for the driving operation, for example, when the driver is asleep. In such a wakefulness state of the driver, when it is necessary to end the lane-keeping control because of, for example, occurrence of an unexpected sudden approach of an additional vehicle, it may be difficult for the driver to immediately take over a driving operation of the host vehicle. Therefore, for example, as the operation condition defined based on the wakefulness state of the driver, a condition that the wakefulness state of the driver is equal to or higher than a degree of wakefulness defined in advance may be defined. The degree of wakefulness here means that the driver is more conscious as the degree of wakefulness is higher, and the driver is in a state closer to a state in which the driver is asleep as the degree of wakefulness is lower. The degree of wakefulness of the driver may be determined, for example, based on an opening degree of eyes of the driver, a shaking degree of a head, and the like obtained from the captured image of the driver monitor camera. For example, it may be determined that the degree of wakefulness of the driver is lower as a degree of the driver's eyes being closed is higher. For example, it may be determined that the degree of wakefulness of the driver is lower as shaking of the head of the driver is larger.

The lane-keeping controller 13 executes the lane-keeping control such that the host vehicle travels along the own lane based on the lane marking of the own lane recognized by the recognition unit 11. The lane-keeping controller 13 controls the steering of the host vehicle by issuing an instruction to the steering actuator 2. The lane-keeping controller 13 executes the lane-keeping control when the operation condition of the lane-keeping control determined by the determination unit 12 is satisfied and the lane marking of the own lane is recognized by the recognition unit 11. As the lane-keeping control based on the lane marking of the own lane, well-known lane-keeping control can be used. Here, the detailed description of the lane-keeping control will be omitted.

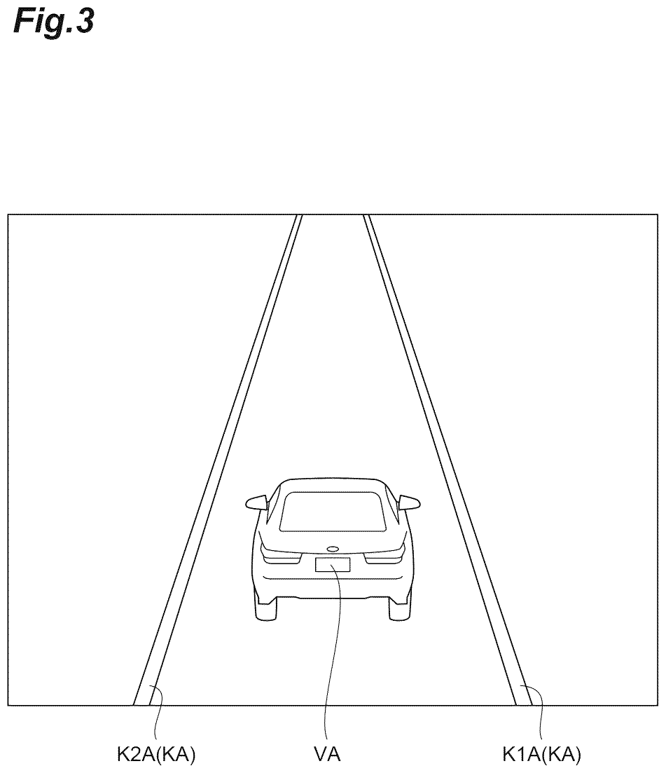

The display controller 14 controls the display of the lane marking on the display 3. The display controller 14 displays the lane marking recognized by the recognition unit 11 on the display 3. In the present embodiment, for example, as shown in FIG. 3, the display controller 14 displays a lane marking KA on the display 3 and displays a host vehicle icon VA indicating the host vehicle. The display controller 14 displays the host vehicle icon VA and the lane marking KA such that the host vehicle icon VA and the lane marking KA are shown in a diagram in which the host vehicle and the lane marking are viewed from the rear and diagonally upward of the host vehicle.

Displaying the lane marking KA on the display 3 is displaying an image (for example, a line) corresponding to the lane marking on the display 3. The lane marking KA includes a lane marking K1A corresponding to the lane marking K1 (refer to FIG. 2) of the own lane L and a lane marking K2A corresponding to the lane marking K2 (refer to FIG. 2) of the own lane L.

The display controller 14 displays the lane marking on the display 3 after a display standby time defined in advance elapses after the recognition of the lane marking is started when the determination unit 12 determines that the operation condition of the lane-keeping control is satisfied when the recognition unit 11 starts the recognition of the lane marking. A time when the recognition of the lane marking is stared is a time when the lane marking can be recognized.

When the determination unit 12 does not determine that the operation condition of the lane-keeping control is satisfied when the recognition unit 11 starts the recognition of the lane marking, the display controller 14 does not display the recognized lane marking on the display 3. Then, when it is determined that the operation condition is satisfied thereafter, the display controller 14 displays the recognized lane marking on the display 3 after the display standby time elapses after it is determined that the operation condition is satisfied.

The display standby time is defined in advance. The display controller 14 can adjust the display standby time based on the following condition. The adjustment of the display standby time may be performed using any two or more of the following conditions. For example, the display controller 14 can increase the display standby time when the host vehicle travels on a general road, as compared with a case where the host vehicle travels on a highway. The highway is a road on which a speed limit is higher than that of the general road, and is a road set for the purpose of high-speed traveling. For example, the display controller 14 can determine whether the host vehicle is traveling on the general road or the highway based on a position of the host vehicle and map information including road types of the general road and the highway. For example, the display controller 14 may determine whether the host vehicle is traveling on the general road or the highway based on a road sign or the like installed on the own lane.

For example, the display controller 14 can increase the display standby time when a recognition length of the lane marking recognized by the recognition unit 11 is short, as compared with a case where the recognition length of the lane marking is long. The recognition length of the lane marking is a length of the lane marking recognized by the recognition unit 11, and is a length along an extension direction of the own lane. The display controller 14 can increase the display standby time when the speed of the host vehicle is low as compared with a case where the speed of the host vehicle is high. As the speed of the host vehicle, the detection result of the vehicle speed sensor installed in the host vehicle may be used.

As described above, when the recognition unit 11 recognizes the lane marking and the determination unit 12 determines that the operation condition of the lane-keeping control is satisfied, the display controller 14 displays the recognized lane marking on the display 3 after the display standby time elapses. Thereafter, the display controller 14 continues to update the display of the lane marking in association with the traveling of the host vehicle.

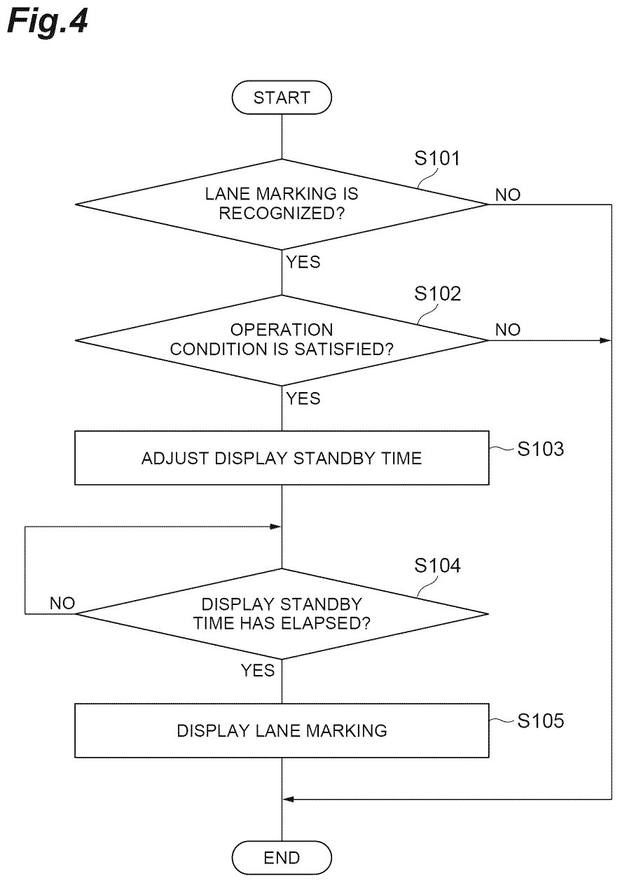

Next, a flow of the display processing of the lane marking performed in the in-vehicle display device 200 of the lane-keeping control system 100 will be described with reference to a flowchart shown in FIG. 4. In processing shown in FIG. 4, after the processing reaches the end, the processing is started again from the start after a predetermined time elapses. As shown in FIG. 4, the recognition unit 11 performs recognition processing of the lane marking of the own lane based on the captured image of the camera 1 (S101). When the lane marking cannot be recognized (S101: NO), the processing proceeds to the end. When the lane marking can be recognized (S101: YES), the determination unit 12 determines whether or not the operation condition of the lane-keeping control of causing the host vehicle to travel along the recognized lane marking is satisfied (S102). When the operation condition is not satisfied (S102: NO), the processing proceeds to the end.

When the operation condition is satisfied (S102: YES), the display controller 14 adjusts the display standby time (S103). Here, as described above, the display controller 14 adjusts the display standby time using whether the host vehicle is traveling on the general road or the highway, the length of the recognized lane marking, and the speed of the host vehicle. However, the display controller 14 may not execute the processing of adjusting the display standby time and may use the display standby time defined in advance. When the operation condition is satisfied, the lane-keeping controller 13 executes the lane-keeping control of the host vehicle.

When it is determined that the operation condition of the lane-keeping control is satisfied when the recognition of the lane marking is started, the display controller 14 determines whether or not the display standby time has elapsed after the recognition of the lane marking is started (S104). Alternatively, when it is not determined that the operation condition of the lane-keeping control is satisfied when the recognition of the lane marking is started and it is determined that the operation condition is satisfied thereafter, the display controller 14 determines whether or not the display standby time has elapsed after it is determined that the operation condition is satisfied (S104). When the display standby time has not elapsed (S104: NO), the display controller 14 repeats determination processing of S104 until the display standby time elapses. When the display standby time has elapsed (S104: YES), the display controller 14 displays the lane marking recognized by the recognition unit 11 on the display 3 (S105).

Here, even when the operation condition of the lane-keeping control is satisfied when the recognition of the lane marking of the own lane is started, a time lag (for example, a slight time lag) may occur until the lane-keeping control is actually operated. Therefore, when the lane marking is displayed at the same time as the recognition of the lane marking is started, the lane marking used for the lane-keeping control is displayed even though the lane-keeping control is not yet in operation, and the occupant may feel incompatibility. Therefore, when the determination unit 12 determines that the operation condition of the lane-keeping control is satisfied when the recognition unit 11 starts the recognition of the lane marking, the in-vehicle display device 200 of the lane-keeping control system 100 displays the lane marking on the display 3 after the display standby time elapses. Accordingly, in the in-vehicle display device 200, even when there is a time lag from the start of the recognition of the lane marking of the own lane to the actual operation of the lane-keeping control, the lane marking is not displayed before the operation of the lane-keeping control, or a time during which the lane marking is displayed before the operation of the lane-keeping control can be shortened. Therefore, it is possible to reduce a feeling of incompatibility of the occupant about the lane-keeping control not being in operation even though the lane marking required for the lane-keeping control is displayed. As described above, the in-vehicle display device 200 can display the lane marking used for the lane-keeping control while reducing a feeling of incompatibility of the occupant.

When the determination unit 12 does not determine that the operation condition of the lane-keeping control is satisfied when the recognition unit 11 starts the recognition of the lane marking, the display controller 14 does not display the recognized lane marking on the display 3. Then, when it is determined that the operation condition is satisfied thereafter, the display controller 14 displays the recognized lane marking on the display 3 after the display standby time elapses after it is determined that the operation condition is satisfied. Accordingly, even when the operation condition of the lane-keeping control is not satisfied when the recognition of the lane marking is started, the in-vehicle display device 200 can display the lane marking at a more appropriate timing while reducing a feeling of incompatibility of the occupant after the operation condition is satisfied.

The display controller 14 increases the display standby time when the host vehicle is traveling on the general road, as compared with a case where the host vehicle is traveling on the highway. For example, when the host vehicle is traveling on the general road, stability of the recognition of the lane marking based on the captured image of the camera 1 tends to be lower as compared with a case where the host vehicle is traveling on the highway. This is because the general road has a complicated road shape, for example, has a sharp curve or includes an intersection, as compared with the highway. Therefore, by increasing the display standby time when the vehicle is traveling on the general road, it is possible to secure an increased time for the recognition processing from the start of the recognition of the lane marking to the display of the lane marking, and it is possible to increase the stability of the recognition of the lane marking. Accordingly, the in-vehicle display device 200 can display the lane marking in a state where the stability of the recognition is high when the lane marking is displayed.

The display controller 14 increases the display standby time when the recognition length of the lane marking recognized by the recognition unit 11 is short, as compared with a case where the recognition length is long. As described above, by increasing the display standby time when the recognition length of the lane marking is short, it is possible to secure increased time for the recognition processing of the lane marking from the start of the recognition of the lane marking to the display of the lane marking. Then, by securing the increased time for the recognition processing, the recognition length of the lane marking (the length of the recognized lane marking) can be increased. That is, for example, the lane marking at a position away from the host vehicle can be recognized. Accordingly, the in-vehicle display device 200 can display a lane marking having a long length when the lane marking is displayed.

The display controller 14 increases the display standby time when the speed of the host vehicle is low, as compared with a case where the speed is high. As described above, by increasing the display standby time when the speed of the host vehicle is low, it is possible to secure increased time for the recognition processing of the lane marking from the start of the recognition of the lane marking to the display of the lane marking. Then, by securing the increased time for the recognition processing, the recognition length of the lane marking (the length of the recognized lane marking) can be increased. That is, for example, the lane marking at a position away from the host vehicle can be recognized. Accordingly, the in-vehicle display device 200 can display the lane marking having the long length when the lane marking is displayed.

### Second Embodiment

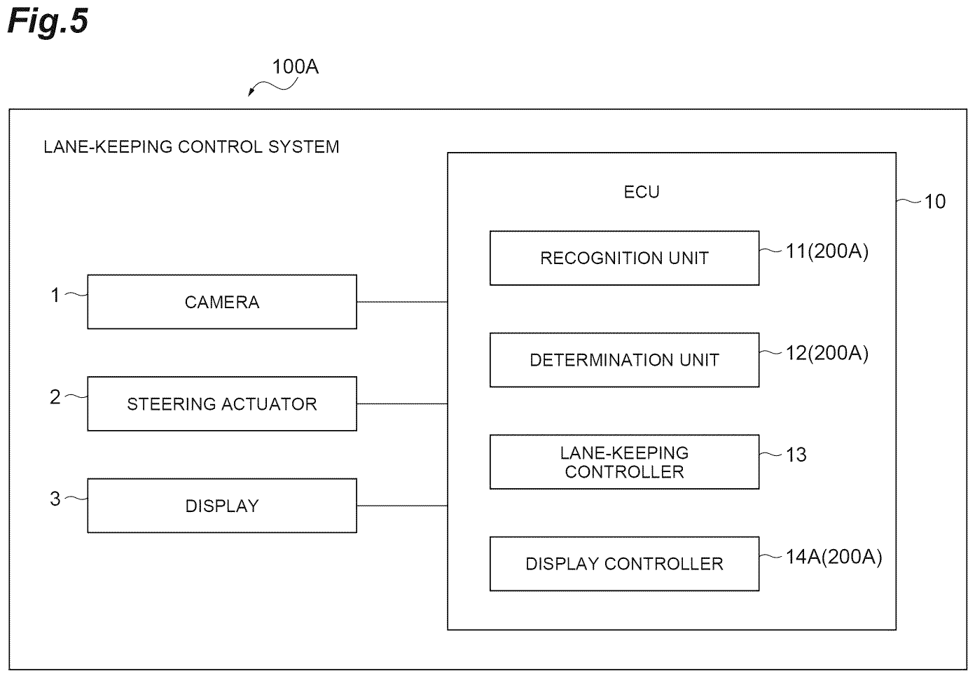

A second embodiment of the lane-keeping control system to which the in-vehicle display device according to the present disclosure is applied will be described. As shown in FIG. 5, a lane-keeping control system 100A according to the present embodiment includes a display controller 14A instead of the display controller 14 of the lane-keeping control system 100 according to the first embodiment. The configurations other than the display controller 14A in the present embodiment are the same as those in the first embodiment, and the detailed description thereof will be omitted. In the present embodiment, the recognition unit 11, the determination unit 12, and the display controller 14A constitute an in-vehicle display device 200A that displays the lane marking of the traveling lane on which the host vehicle travels on the display 3.

The display controller 14A controls the display of the lane marking on the display 3. The display controller 14A displays the lane marking recognized by the recognition unit 11 on the display 3. For example, as shown in FIG. 3, the display controller 14A displays the lane marking KA on the display 3 and displays the host vehicle icon VA indicating the host vehicle.

When the determination unit 12 determines that the operation condition of the lane-keeping control is satisfied when the recognition unit 11 starts the recognition of the lane marking, the display controller 14A displays the recognized lane marking on the display 3 when the lane-keeping controller 13 starts the lane-keeping control. The display controller 14A can acquire information on whether or not the execution of the lane-keeping control is started from the lane-keeping controller 13. A time when the execution of the lane-keeping control is started is a time when the operation condition of the lane-keeping control is satisfied, preparation for the execution of the lane-keeping control is made, and the execution of the lane-keeping control is actually started.

When the determination unit 12 does not determine that the operation condition of the lane-keeping control is satisfied when the recognition unit 11 starts the recognition of the lane marking, the display controller 14A does not display the recognized lane marking on the display 3. Then, when it is determined that the operation condition of the lane-keeping control is satisfied, the display controller 14A displays the recognized lane marking on the display 3 when the lane-keeping controller 13 starts the execution of the lane-keeping control.

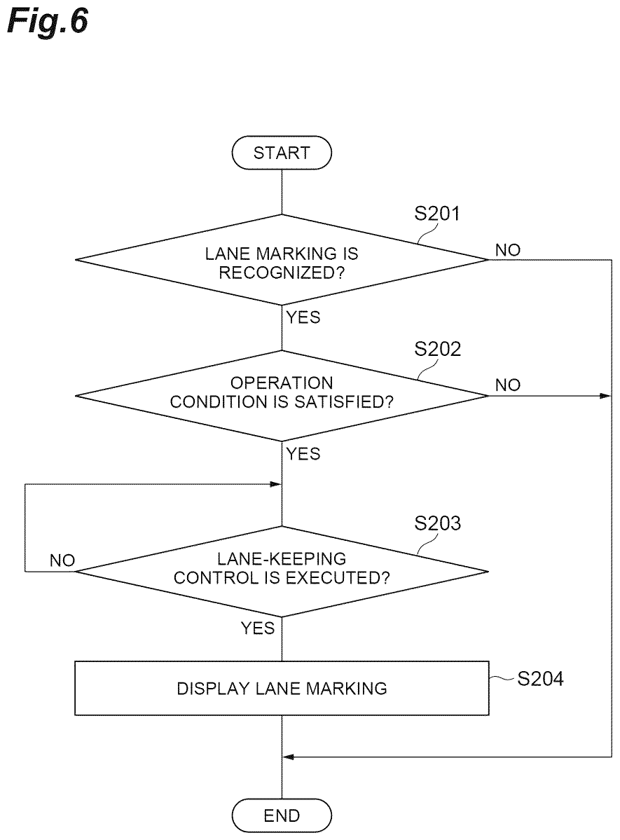

Next, a flow of the display processing of the lane marking performed in the in-vehicle display device 200A of the lane-keeping control system 100A will be described with reference to a flowchart shown in FIG. 6. In the processing shown in FIG. 6, after the processing reaches the end, the processing is started again from the start after a predetermined time elapses. Processing of S201 and S202 shown in FIG. 6 is the same as the processing of S101 and S102 described with reference to FIG. 4, and the description thereof will be omitted.

When it is determined that the operation condition of the lane-keeping control is satisfied (S202: YES), the display controller 14A determines whether or not the lane-keeping controller 13 executes the lane-keeping control (S203). When the lane-keeping control is not executed (when not in operation) (S203: NO), the display controller 14A repeats determination processing of S203 until the lane-keeping control is executed. When the lane-keeping control is executed (when in operation) (S203: YES), the display controller 14A displays the lane marking recognized by the recognition unit 11 on the display 3 (S204).

Here, even when the operation condition of the lane-keeping control is satisfied when the recognition of the lane marking of the own lane is started, a time lag (for example, a slight time lag) may occur until the lane-keeping control is actually operated. Therefore, when the lane marking is displayed at the same time as the recognition of the lane marking is started, the lane marking used for the lane-keeping control is displayed even though the lane-keeping control is not yet in operation, and the occupant may feel incompatibility. Therefore, when the operation condition of the lane-keeping control is satisfied when the recognition of the lane marking of the own lane is started, the in-vehicle display device 200A of the lane-keeping control system 100A displays the lane marking when the lane-keeping controller 13 starts the execution of the lane-keeping control. Accordingly, in the in-vehicle display device 200A, it is possible to reduce a feeling of incompatibility of the occupant about the lane-keeping control not being in operation even though the lane marking required for the lane-keeping control is displayed. As described above, the in-vehicle display device 200A can display the lane marking used for the lane-keeping control while reducing a feeling of incompatibility of the occupant.

When the determination unit 12 does not determine that the operation condition of the lane-keeping control is satisfied when the recognition unit 11 starts the recognition of the lane marking, the display controller 14A does not display the recognized lane marking on the display 3. Then, when it is determined that the operation condition is satisfied thereafter, the display controller 14A displays the lane marking on the display 3 when the lane-keeping control is started. Accordingly, even when the operation condition of the lane-keeping control is not satisfied when the recognition of the lane marking is started, the in-vehicle display device 200A can display the lane marking at a more appropriate timing while reducing a feeling of incompatibility of the occupant after the operation condition is satisfied.

Although various embodiments of the present disclosure have been described above, the present disclosure is not limited to each of the above-described embodiments. For example, the display of the lane marking on the display 3 shown in FIG. 3 and the like is an example, and is not limited to, for example, a diagram in which the host vehicle and the lane marking are viewed from the rear and diagonally upward of the host vehicle. For example, a diagram (plan view) in which the host vehicle and the lane marking are viewed from above may be displayed on the display 3.

What is claimed is:

1. An in-vehicle display device that displays a lane marking of a traveling lane on which a vehicle travels on a display mounted on the vehicle, the in-vehicle display device comprising:
a recognition unit configured to recognize the lane marking of the traveling lane based on a captured image of a camera;
a determination unit configured to determine whether or not an operation condition of lane-keeping control of causing the vehicle to travel along the recognized lane marking is satisfied, the operation condition being set based on at least one of a state of the vehicle, a shape of the traveling lane, and a state of a driver of the vehicle; and
a display controller configured to display the recognized lane marking on the display,
wherein the display controller is configured to display the lane marking after a display standby time set in advance elapses when the determination unit determines that the operation condition is satisfied when the recognition unit starts the recognition of the lane marking.

2. The in-vehicle display device according to claim 1,
wherein the display controller is configured to
not display the recognized lane marking when the determination unit does not determine that the operation condition is satisfied when the recognition unit starts the recognition of the lane marking, and
display, when it is determined that the operation condition is satisfied thereafter, the lane marking after the display standby time elapses after it is determined that the operation condition is satisfied.

3. The in-vehicle display device according to claim 1,
wherein the display controller increases the display standby time when the vehicle travels on a general road, as compared with a case where the vehicle travels on a highway.

4. The in-vehicle display device according to claim 1,
wherein the display controller increases the display standby time when a recognition length of the lane marking recognized by the recognition unit is short, as compared with a case where the recognition length of the lane marking is long.

5. The in-vehicle display device according to claim 1,
wherein the display controller increases the display standby time when a speed of the vehicle is low, as compared with a case where the speed is high.

6. An in-vehicle display device that displays a lane marking of a traveling lane on which a vehicle travels on a display mounted on the vehicle, the in-vehicle display device comprising:
a recognition unit configured to recognize the lane marking of the traveling lane based on a captured image of a camera;
a determination unit configured to determine whether or not an operation condition of lane-keeping control of causing the vehicle to travel along the recognized lane marking is satisfied, the operation condition being set based on at least one of a state of the vehicle, a shape of the traveling lane, and a state of a driver of the vehicle; and
a display controller configured to display the recognized lane marking on the display,
wherein the display controller is configured to display the lane marking when the execution of the lane-keeping control is started when the determination unit determines that the operation condition is satisfied when the recognition unit starts the recognition of the lane marking.

7. The in-vehicle display device according to claim 6,
wherein the display controller is configured to
not display the recognized lane marking when the determination unit does not determine that the operation condition is satisfied when the recognition unit starts the recognition of the lane marking, and
display, when it is determined that the operation condition is satisfied thereafter, the lane marking when the execution of the lane-keeping control is started.
